(19) United States
(12) Patent Application Publication
(10) Pub. No.: US 2003/0134531 A1
(43) Pub. Date: Jul. 17, 2003

(54) Adapter for electrical plug-in connections on fuel-injection valves

(76) Inventor: Heinz Luft, Hirschaid (DE)

Correspondence Address: KENYON & KENYON, ONE BROADWAY, NEW YORK, NY, 10004, US

(21) Appl. No.: 10/296,406

(22) PCT Filed: Mar. 27, 2002
(86) PCT No.: PCT/DE02/01128

(30) Foreign Application Priority Data
Mar. 27, 2001 (DE) 101 15 049.0

(51) Int. Cl. H01R 13/44

(52) U.S. Cl. 439/130

(57) ABSTRACT

An adapter (1) is described for connecting an electrical plug-in connector (4) of a fuel injector to a counterplug (6), whose first end (3) is pluggable into a plug-in connector (4) of the fuel injector and whose second end (5) is pluggable into counterplug (6) of the electrical line. A first seal (7) being positioned between the first end (3) of the adapter (1) and the plug-in connector (4) of the fuel injector and a second seal (8) being positioned between the second end (5) of the adapter (1) and the counterplug (6).

### BACKGROUND INFORMATION

The present invention is directed to an adapter for electrical plug-in connections on fuel injectors according to the definition of the species in the main claim.

The electrical contact between an actuator of a fuel injector and the voltage source is typically produced via a plug-in connection system, in which the plug is shaped so that it may be plugged in a form-fitting way into the plug-in connector on the fuel injector. The plug and the plug-in connector are producible in this case from plastic, using injection molding. The plug-in connection is additionally to be designed so that the electrical contacts are sealed in relation to the surroundings to protect against corrosion, in order to counteract subsequent contact weaknesses.

The high manufacturing outlay which is required if changes are to be implemented on the plug or on the plug-in connector of the fuel injector is disadvantageous in known plug-in connection systems. Thus, for example, the requirements of different clients, caused by differently shaped plugs which are specific to the client, may only be implemented using different injection molds and extensive mounting and demounting of the molds, which results in long setup times.

### ADVANTAGES OF THE INVENTION

The adapter according to the present invention for electrical plug-in connections for a fuel injector having the features of the main claim has the advantage over the related art that changes in the shape of the counterplug only require changes in the shape of the adapter, which may be implemented easily, and therefore rapidly and cost-effectively, but not in the shape of the plug-in connector of the fuel injector.

In addition, the adapter is distinguished by a reliable seal of the electrical contacts in relation to the surroundings.

Advantageous refinements and improvements of the adapter indicated in the main claim are possible through the measures described in the subclaims.

It is also advantageous that seals between the counterplug and the adapter and/or between the adapter and the plug-in connector of the fuel injector may be implemented variably as radial or axial seals, depending on the requirements placed on the plug-in connector.

The elastic spring shackles on the ends of the contact tabs of the adapter, the counterplug, and/or the plug-in connector ensure, through clamping, a reliable contact and protection against unintended detachment of the plug-in connection.

The adapter is advantageously secured on the plug-in connector of the fuel injector by a spring buckle, through which easier connectability to the counterplug of the electrical line may be achieved.

### DRAWING

An exemplary embodiment of the present invention is illustrated in simplified form in the drawing and explained in more detail in the following description.

FIG. 1 shows a schematic section through an exemplary embodiment of an adapter implemented according to the present invention, and

FIG. 2 shows a schematic section through the adapter implemented according to the present invention illustrated in FIG. 1 along line II-II in FIG. 1.

### DESCRIPTION OF THE EXEMPLARY EMBODIMENT

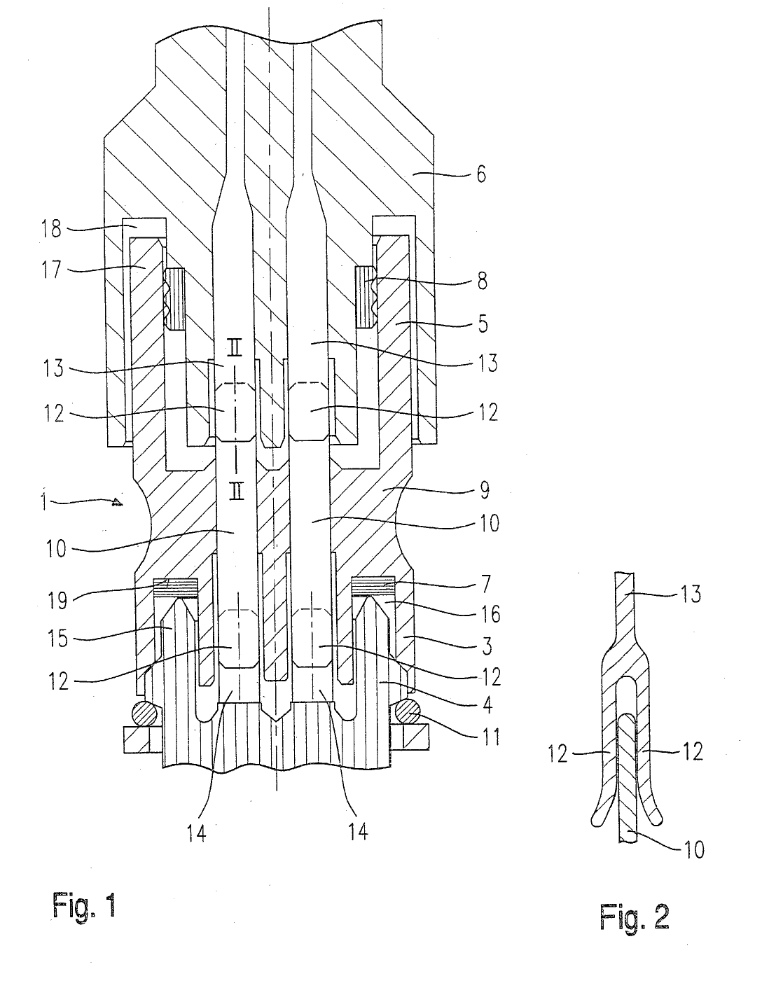

FIG. 1 shows a schematic sectional illustration of a view of an adapter 1 implemented according to the present invention for connecting a plug-in connector 4 of a fuel injector to a counterplug 6 of an electrical line, which leads, for example, to an electronic control unit (not shown). Counterplug 6 is connectable to the fuel injector via adapter 1 and permits the electrical contact for actuating the fuel injector.

Adapter 1 is implemented in this case in the shape of a round or oval cylindrical body 9, whose first end 3 may be plugged into plug-in connector 4 of the fuel injector and whose second end 5 may be plugged into counterplug 6 of the electrical line.

Plug-in connector 4 of the fuel injector is implemented in this case in the shape of a sleeve 15, which is preferably made of plastic and is also sprayed during spray coating of the fuel injector. In this case, sleeve 15 projects over contact tabs 14, necessary for producing the contact, which are connected, for example, to an actuator (not shown) of the fuel injector. After adapter 1 is plugged into plug-in connector 4, sleeve 15 is inserted into a recess 16 of adapter 1, in which a first seal 7, which is implemented in the present exemplary embodiment as axial seal 7, is positioned on a recess base 19 of recess 16. In this case, sleeve 15 presses against first seal 7 to form a seal, so that contact tabs 14 of plug-in connector 4 are sealed against the surroundings.

Contact tabs 14 of plug-in connector 4 are positioned next one another in the preferred exemplary embodiment and produce an electrically conductive connection to contact tabs 10 of adapter 1 via elastic spring shackles 12 implemented on contact tabs 10 or 14. Elastic spring shackles 12 are illustrated in FIG. 2 in a sectional view and described in more detail for clarification.

Counterplug 6 of the electrical line is plugged into a second end 5 of adapter 1. Counterplug 6 illustrated in FIG. 1 is an AKD plug, which also has two contact tabs 13. Contact tabs 13 may also be conductively connected to one another using elastic spring shackles 12, which may be implemented either on contact tabs 13 of counterplug 6 or on contact tabs 10 of adapter 1. In the present exemplary embodiment, spring shackles 12 are implemented on contact tabs 13 of counterplug 6.

On its second end 5, adapter 1 has a sleeve 17 which extends into a recess 18 of counterplug 6. A second seal 8, which seals contact tabs 13 of counterplug 6 against the surroundings, is positioned between contact tabs 13 of counterplug 6 and sleeve 17 of adapter 1. Second seal 8 is implemented in this case as a radial seal 8 in the form of a shaft ring and/or a labyrinth seal.

As an additional safety measure, adapter 1 may be secured using a spring buckle 11 or a similar retention device after being plugged into plug-in connector 4 of the fuel injector, which prevents adapter 1 from slipping out of plug-in connector 4 and simultaneously makes plugging counterplug 6 into adapter 1 easier.

Counterplug 6 is preferably manufactured from plastic, contact tabs 13 of counterplug 6 being embedded in the plastic. By using an additional component in the form of adapter 1, complete sealing of contact tabs 13 and 14 may be achieved using seals 7 and 8 and, at the same time, the long setup times and expensive molds for manufacturing and mounting different plug systems may be dispensed with.

In a sectional detail illustration, FIG. 2 shows a section through the connection point between contact tabs 10 of adapter 1 and contact tabs 13 of counterplug 6, along the line indicated with II-II in FIG. 1. Identical components are provided with the same reference numbers in this case.

The connection between plug-in connector 4 of the fuel injector and adapter 1 and between adapter 1 and counterplug 6 of the electrical line must be distinguished by easy pluggability and a certain stability in relation to tensile load. This may be produced using elastic spring shackles 12, already described briefly in relation to FIG. 1, which may be implemented on contact tabs 10, 13, and 14 of adapter 1, counterplug 6, or plug-in connector 4. In this case, two forked spring shackles 12, which are connected to one another, always work together, particular opposing contact tabs 10, 13, or 14 being inserted between them when adapter 1 is plugged into plug contact 4 and/or when counterplug 6 is plugged into adapter 1.

In the preferred exemplary embodiment illustrated in FIG. 1, elastic spring shackles 12, into which contact tabs 14 of plug-in connector 4 are inserted, are implemented on contact tabs 10 of adapter 1 facing plug-in connector 4, while on the opposite side, elastic spring shackles 12 are implemented on contact tabs 13 of counterplug 6 facing contact tabs 10 of adapter 1, so that contact tabs 10 of adapter 1 are plugged into spring shackles 12 of contact tabs 13.

The present invention is not restricted to the exemplary embodiment illustrated and is manufacturable for any desired shape of counterplug 6.

What is claimed is:

1. An adapter (1) for connecting an electrical plug-in connector (4) of a fuel injector to a counterplug (6), a first end (3) of the adapter (1) being pluggable into the plug-in connector (4) of the fuel injector and a second end (5) of the adapter (1) being pluggable into the counterplug (6),
a first seal (7) being positioned between the first end (3) of the adapter (1) and the plug-in connector (4) of the fuel injector and a second seal (8) being positioned between the second end (5) of the adapter (1) and counterplug (6).

2. The adapter as recited in claim 1,
wherein the first seal (7) is implemented as an axial seal (7).

3. The adapter as recited in claim 1 or 2,
wherein the second seal (8) is implemented as a radial seal (8).

4. The adapter as recited in one of claims 1 through 3,
wherein the adapter (1) has a body (9) which is made of an electrically non-conductive material.

5. The adapter as recited in claim 4,
wherein contact tabs (10) are embedded in the body (9).

6. The adapter as recited in claim 5,
wherein the contact tabs (10) of the adapter (1) have elastic spring shackles (12) on at least one end.

7. The adapter as recited in claim 6,
wherein the elastic spring shackles (12) are implemented in pairs as forked tongues.

8. The adapter as recited in claim 7,
wherein the elastic spring shackles (12) are pluggable into contact tabs (13) of the counterplug (6) and/or into contact tabs (14) of the plug-in connector (4) of the fuel injector.

9. The adapter as recited in one of claims 1 through 8,
wherein the adapter (1) may be fixed on the plug-in connector (4) of the fuel injector using a spring buckle (11).
